(19) United States
(12) Patent Application Publication
(10) Pub. No.: US 2008/0121473 A1
(43) Pub. Date: May 29, 2008

(54) PARKING BRAKE SYSTEM USING TAPERED ROLLER IN RAMP-TYPED BRAKE CALIPER FOR VEHICLE

(75) Inventor: Kyung Soo KANG, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/616,152

(22) Filed: Dec. 26, 2006

(30) Foreign Application Priority Data
Nov. 23, 2006 (KR) 10-2006-0116197

(51) Int. Cl. F16D 55/16

(52) U.S. Cl. 188/72.7

(57) ABSTRACT

The present invention relates to a parking brake system using a tapered roller in ramp-typed brake caliper for vehicles, in which because a tapered roller in ramp-typed caliper that generates parking brake force through axial force in the operation of a parking brake system is mounted, stable axial force is generated and relatively large contact areas are obtained by axial surface contacts by tapered rollers, so that it does not require forging with very high precision that is required for ball in ramp-typed ramps with point contact, thus the manufacturing process comes In be easy,

### CROSS-REFERENCE TO RELATED APPLICATIONS

The present application is based on, and claims priority from, Korean Application Serial Number 10-2006-0116197, filed on Nov. 23, 2006, the disclosure of which is hereby incorporated by reference herein in its entirety

### FIELD OF THE INVENTION

The present invention relates to a parking brake system for a vehicle, particularly a parking brake system using a tapered roller in ramp-typed brake caliper that generates axial force holding a wheel disc by surface-contact in operation.

### BACKGROUND OF THE INVENTION

In general, a parking brake system used to temporally park or stop vehicles on an inclined road, such as a slope, is designed to press wheels using a manually pulled cable and actuated by operating a parking lever at a side of the driver's seat, unlike a common brake system that presses wheels using hydraulic pressure through a pedal.

These parking brake systems include a parking lever that is manually operated, a parking brake cable that is pulled or released through a ratchet assembly (not shown) provided to the lever and actuated by operating a release knob that releases the brake, and an equalizer that is provided between left and right cables connected with the left and right rear wheels to uniformly distribute operational force.

The parking brake system is generally operated when wheels are locked by a strong pressing force that is generated by pressing pads against drums in the wheels through operational force of a parking brake.

Instead of the method of pressing the pad against the drum, a method of using calipers in which wheels are disposed between the pads to perform braking is used. Calipers constituting such parking brake systems and applying brake force to wheels are called BIR calipers (Ball In Ramp Caliper).

The way the ball in ramp calipers operate is as follows; as a parking lever is pulled, axial force is generated inside a ball in ramp caliper, balls inside the caliper move along a path of a ramp pulled by the axial force, and the axial force increased by the changes in position of the balls along the path of the ramp acts as a parking brake force by pressing pads against wheels.

However, when the ball in ramp calipers generate parking brake force in a parking brake system, axial force (force pushing pads to the discs) generated by operational force of the parking brake system only depends on the movement of the balls along a path of a ramp, and in the generating of the axial force, the ramp with the path for the balls should be uniformly shaped with precisely machined surfaces for accurate transmission of an axial load. Therefore, it is difficult to manufacture the caliper.

Further, because balls substantially generating axial force are disposed between ramps, duplicate paths of the ramps for the balls rolling and moving are formed and it takes a long time to manufacture ramps having uniformity and precision on the surfaces.

In addition, because ramps that are difficult to manufacture as described above undergo precise forging, it is more difficult to manufacture the ramps and obtain desired quality due to the limitations.

It is an object of the invention to make the manufacturing process easy without requiring forging with very high precision that is required for ball in ramp-typed ramps with a pointed contact by using a tapered roller in the ramp-typed caliper that generates parking brake force through an axial force during the operation of a parking brake is mounted, stable axial force with relatively large contact area is generated by axial surface contacts of tapered rollers.

### SUMMARY OF THE INVENTION

Embodiments of the present invention provide a parking brake system using tapered roller in ramp-typed brake caliper for a vehicle that includes a parking brake operating part, a caliper unit, a brake force transmitting part, and a brake force generating part. The caliper unit generates operational force to uniformly pull a parking cable through an equalizer while operating a parking lever. The caliper unit converts the force pulling the parking cable into rotational force and axial force and covers both sides of a wheel disc to press pads against the sides and maintain brake force while operating the parking brake operating part. The brake force transmitting part axially moves the pads to press the sides of the wheel disc, inside a caliper housing forming the whole shape to the caliper unit. The brake force generating part includes an input ramp, an axial moving member, an output ramp, and a spring. The input ramp has an end connected with a cable connector fastened to the parking cable at the outside of the caliper housing and rotates due to the pulling force of the cable connector The axial moving member has tapered rollers moving through rolling along V-shaped cross-sectional path grooves formed on the input ramp. The output ramp has V-shaped cross-sectional path grooves for the tapered rollers to roll and is axially pushed by the movement of the tapered rollers and axially presses the brake force transmitting part. The spring is compressed as the output ramp axially moves and applies elastic restoring force to the output ramp as the axial force is released.

According to an embodiment of the invention, the portion where the rod of the input ramp and the cable connector are connected may be covered with a sealing cap to seal oil filled in the caliper housing. Further the portion may be provided with a sealing ring of an elastic material. The output ramp may be provided with a holder housing that receives the spring and is locked by locking bosses protruding from the outer circumference of the pressing plate defining the end of the rod of the output ramp.

According to another embodiment of the invention, the input ramp may include a rod and a rotary plate. The rod may protrude outside the caliper housing and may be connected with the cable connector to rotate when the parking cable is pulled. The rotary plate may have the V-shaped cross-sectional grooves to seat the tapered rollers of the axial moving member.

According to another embodiment of the invention, the axial moving member may include a stationary plate and tapered rollers. The stationary plate may be disposed between the input ramp and the output ramp. The tapered rollers may be rotatably assembled in the stationary plate and positioned in the path grooves of the input ramp and output ramp.

According to another embodiment of the invention, the output ramp may include a pressing plate and a rod. The pressing plate may have V-shaped cross-sectional path grooves to seat the tapered rollers of the axial moving member The rod may extend from the pressing plate and has a smaller diameter than that of the pressing plate to fit the spring.

According to another embodiment of the invention, the axial moving member may be supported by a supporting shaft fitted into a central hole. Both ends of tile supporting shaft may be respectively inserted in central holes of the rotary plate of the input ramp and the pressing plate of the output ramp.

### BRIEF DESCRIPTION OF THE DRAWINGS

For a better understanding of the nature and objects of the present invention, reference should be made to the following detailed description with the accompanying drawings, in which:

FIG. 1 is a view illustrating the configuration of a parking brake using a tapered roller in ramp-typed brake caliper according to an embodiment of the invention; and

FIGS. 2A and 2B are views illustrating the operation of a brake force generating part that generates axial force in a caliper when a parking brake is operated.

### DETAILED DESCRIPTION OF THE PREFERRED EMBODIMENTS

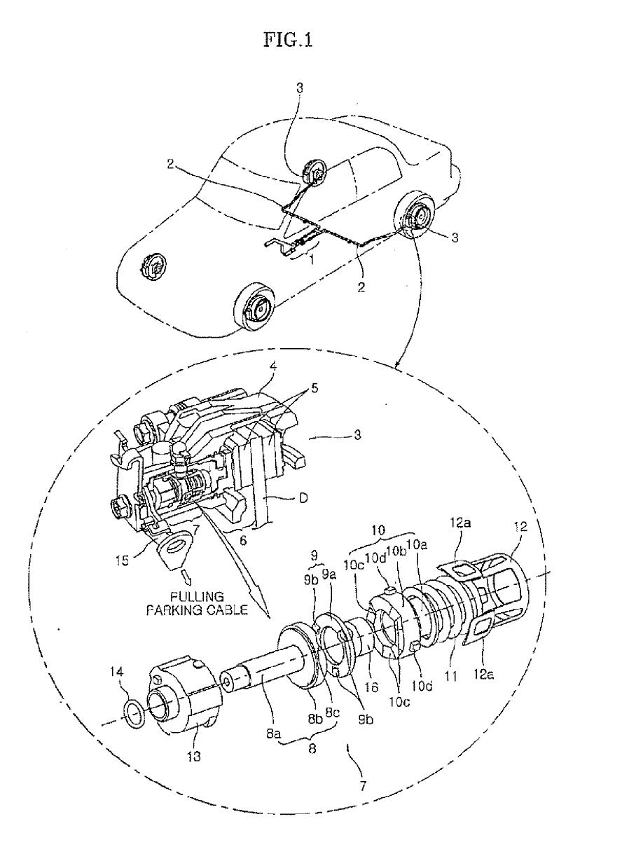

FIG. 1 is a view illustrating the configuration of a parking brake system using a tapered roller in ramp-typed brake caliper according to an embodiment of the invention. Referring to FIG. 1, a parking brake system according to an embodiment of the invention includes a parking brake operating part 1 that uniformly distributes operational force of a lever operated inside a vehicle through an equalizer, a parking cable 2 that is pulled through the equalizer and transmits the operational force during the operation of the parking brake operating part 1, and caliper units 3 that generates parking brake force by rotating and convening the parking brake operating force into axial force pressing pads 5 against wheel discs D as the parking cable 2 is pulled.

Caliper unit 3 includes a caliper housing 4 that covers both sides of wheel disc D of a wheel, a brake force generating part 7 that is mounted in caliper housing 4 to generates rotational force from the force pulling the parking cable 27 and a brake force transmitting part 6 that maintains parking brake force by moving pads 5 to both sides of wheel disc D using axial force generated at the braking force generating part 7.

As for brake force transmitting part 6, as parking cable 2 is pulled, a ramp rotates and another ramp axially moves accordingly, and brake force transmitting part 6 axially moves by the axial force and presses the pad 5 against wheel disc D, and results in generating parking brake force. This operation is the same as the common BIR (Ball In Ramp) calipers that also press pads against a wheel disc using axial force transmitted through balls arid ramps.

Brake force generating part 7 includes an input ramp 8 of which the end is connected with a cable connector 15 fastened to parking cable 2 pulled from the outside of caliper unit 3 and rotates by the pulling force through cable connector 15, an axial moving member 9 that generates axial force by contact with input ramp 8 as the input ramp 8 rotates, a output ramp 10 that axially moves by the axial force generated from axial moving member 9 and generates brake force pressing the pad 5 against wheel disc D, and a spring 11 that is compressed as output ramp 10 axially moves, and applies elastic restoring force to output ramp 10 when the axial force is released.

The spring 11 is a coil spring.

Output ramp 10 includes a holder housing 12 that receives and restricts the position of the spring 11 and is locked to locking bosses 10d protruding along the outer circumference of a pressing plate 10b forming the end of a rod 10a of output ramp 10. The holder housing 12 is located in the caliper housing 4 so as not to be movable.

Locking ends 12a having holes where protruding locking bosses 10d of output ramp 10 are inserted are formed to have a predetermined width and length along the circumference of pressing plate 10b of output ramp 10, while a seating surface is formed opposite to locking ends 12a to support the spring 11. As for the whole structure, the portion surrounding and seating the spring 11 narrows and only the locking ends 12a form the circumference with openings, at a predetermined interval.

A hole having a predetermined size is formed through locking end 12a to lock locking boss 10d of output ramp 10. The size is determined such that it does not restrict the stroke of locking boss 10d that correspondingly moves when the output ramp 10 axially moves. Other holes are formed through the other portions other than those for locking bosses 10d to generally reduce frames formed at locking ends 12a.

Locking ends 12a of holder housing 12 are more than one, preferably equally arranged at three predetermined positions of 120° to stably distribute force, in general Locking bosses 12a protruding from pressing plate 10b forming the end of rod 10a are formed at output ramp 10, the same as locking ends 12a, such that they lock spring 11 by locking locking ends 12a of holder housing 12.

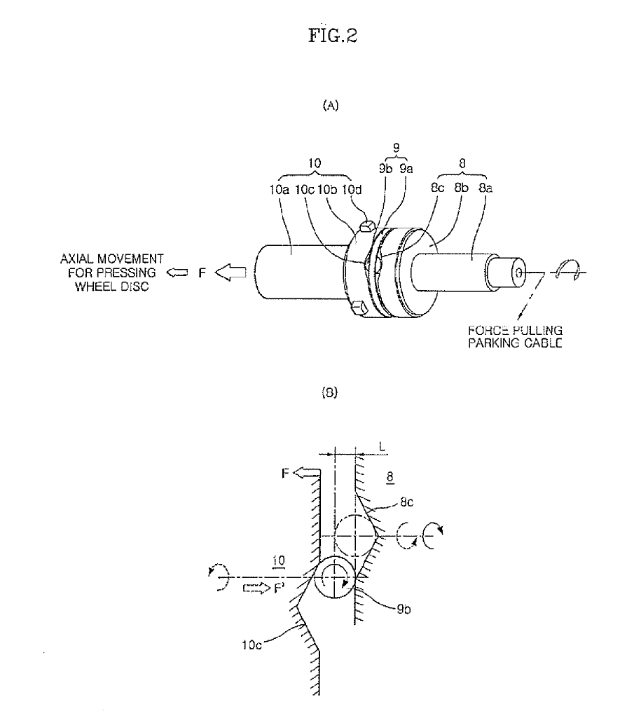

As the pulling force of parking cable 2 transmitted to cable connector 15 is converted into rotational force, brake force transmitting part 6 converts the rotational force into axial force to press pad 5 against disc D. In detail, as shown in FIG. 2, as axial moving part 9 positioned between path grooves formed at input ramp 8 and output ramp 10 moves in longitudinal surface contact, brake force transmitting part 6 moves.

For this reason, axial moving member 9 includes a stationary plate 9a between input ramp 8 and output ramp 10 and tapered rollers 9b rotatably assembled in stationary plate 9a and disposed in path grooves 8c, 10c of input ramp 8 and output ramp 10.

Path grooves 8c, 10c formed at regular intervals on rotary plate 8b of input ramp 8 and pressing plate 10b of output ramp 10 facing each other have V-shaped cross-sections as shove in FIG. 2B, and tapered rollers 9b of axial moving member 9 are longitudinally positioned on the V-shaped cross-sectional areas.

Because path grooves 8c, 10c each have a V-shaped cross section and tapered rollers 9b of axial moving member 9 are in surface contact and roll along the V-shaped cross-sectional grooves, it is not needed to machining path grooves 8c, 10c with very high precision in forging by comparison with balls, so that the productivity is improved.

Each of path grooves 8c, 10c of input ramp 8 and output ramp 10 and tapered roller 9b of axial moving member 9 can be more than one, but it is preferable to arrange them at three predetermined positions of 120°.

Tapered roller 9b is shaped as a longitudinially tapered cylinder having one end with a larger diameter than the other, and when it is assembled into stationary plate 9a, the end having a larger diameter of tapered roller 9b faces the outside of stationary plate 9a.

Both ends of tapered roller 9b are supported by stationary plate 9a, so that tapered roller 9b freely rotate such as balls in bearings. For example, tapered roller 9b may be assembled in stationary plate 9a by inserting protrusions at the ends into the groove on stationary plate 9a, by inserting protrusions formed in a receiving groove for tapered roller 9b of stationary plate 9a into grooves at the ends, or by forming grooves in the receiving groove for tapered roller 9b of stationary plate 9a and inserting both ends of a pin shaft passing through tapered roller 9b into the grooves.

Axial moving member 9 is supported by a supporting shaft 16 by fitting supporting shaft 16 in a central through hole and the ends of supporting shaft 16 are each inserted in central holes of rotary plate 8b of input ramp 8 and pressing plate 10b of output ramp 10.

A sealing cap 13 is fitted to rod 8a of input ramp 8 connected with cable connector 15 to seal oil filled in caliper housing 4 and a sealing ring 14 is interposed between sealing cap 13 and rod 8a.

Sealing cap 13 forms a protrusion that protrudes with a small diameter out of a body in caliper housing 4 and surrounds rod 8a of input ramp to reduce the exposed portion.

The operation of an embodiment of the invention is now described hereafter with reference to the accompanying drawings.

A parking brake system according to an embodiment of the invention uses a tapered roller in ramp-typed caliper for a brake that generates axial force with surface contact, so that it does not require very precise forging, which is required for ball in ramp-typed calipers generating axial force with line contact, and holds wheel discs D by, generating sufficient axial force during its operation.

As shown in FIG. 1, in mounting a tapered roller in a ramp that generates parking brake force through rotation and axial movement in a caliper of a parking brake configured as described above, brake force generating part 7, brake force transmitting part 6, and pads 5 are sequentially joined in caliper housing 4 that forms a general outer shape and covers both sides of wheel disc D.

Brake force generating part 7 positioned ahead of brake force transmitting part 6 pressing pads 5 at both sides of wheel disc D against wheel disc D is assembled such that axial moving member 9 where a supporting, shaft 16 is fitted is positioned between input ramp 8 and output ramp 10, in which holder housing 12 is locked to holding bosses 10d protruding from pressing, plate 10b of output ramp 10 and spring contacts with brake force transmitting part 6 in holder housing 12.

An end of rod 8a of input ramp 8 connected with output ramp 10 through axial moving member 9 is positioned outside caliper housing 4 and cable connector 15 is connected to the end of rod 8a.

Rod 8a of input ramp 8 connected with cable connector 15 is provided with sealing to prevent oil (lubricant) filled inside caliper housing 4 from leaking. Accordingly, rod 8a of input ramp 8 penetrates caliper housing 4 and sealing ring 14 is additionally provided to the portion when rod 8a is fitted.

As for the initial condition of assemble of axial moving member 9 between input ramp 8 and output ramp 9, as shown in FIGS. 2A and 2B, tapered rollers 9b are longitudinally interposed in V-shaped cross-sectional path grooves 8c, 10c formed at a rotary plate 8b of input ramp 8 and pressing plate 10b of output ramp 10.

The initial position of tapered roller 9b of axial moving member 9 is determined to widen input ramp 8 and output ramp 10 due to tie diameter while rolling along the path of grooves 8c, 10c during the operation of the parking brake system, and to generate parking brake force that allows brake force transmitting part 6 to move pads 5 to wheel disc D by axially moving output ramp 10 due to the widening.

The operation of a parking brake system using a tapered roller in ramp-typed caliper according to an embodiment of the invention is very similar to common parking brake systems using a ball in ramp-typed caliper, which is now described with reference to the accompanying drawings.

When a lever (general parking lever) consisting of parking brake operating part 1 is pulled to parking-brake a vehicle, as shown in FIG. 1, pulling force acting on the lever uniformly pulls parking cable 2 through an equalizer and acts as axial force in the caliper unit 3 mounted to wheel discs D of wheels. The axial force in caliper unit 3 presses pads 5 against both sides of wheel discs D and finally acts as parking brake force.

The operation of caliper unit 3 is described in details. As cable connector 15 connected to parking cable 2 is pulled by parking cable 2, brake force generating part 7 of which an end is fixed to cable connector 15 rotates and generates axial force to wheel disc D.

As brake force generating part 7 operates, input ramp 8 rotates (e.g. clockwise) due to the pulling force of cable connector 15, axial moving member 9 axially moves as input ramp 8 rotates, and output ramp 10 axially moves due to the movement of axial moving part 9.

As shown in FIGS. 2A and 2B, by freely rotating and rolling along path grooves 8c formed on rotary plate 8b of input ramp 8, tapered rollers 9b of axial moving member 9 move to ends of the V-shaped cross-sectional path grooves 8c, 10c of input ramp 8 and output ramp 10 facing each other. Accordingly, as rolling, tapered rollers 9b push pressing plate 10b of output ramp 10 away from rotary plate 10b of input ramp 8.

When a gap L is formed between input ramp 8 and output ramp 10 facing each other as tapered rollers 9b move as described above, force F corresponding to the axial gap L axially pushes output ramp 10 and then output ramp 10 pushes brake force transmitting part 6 accordingly.

Since tapered rollers 9b of axial moving part 9 are positioned at predetermined spaces, they uniformly move on input ramp 8 and simultaneously apply uniform axial force F to output ramp 10.

As output ramp 10 is pushed in an axial stroke, it compresses spring 11, that is, compresses spring 11 between pressing plate 10b forming the end for rod 10a of in output ramp 10 and holder housing 12, and presses brake force transmitting part 6. The force pressing brake force transmitting part 6 is converted into parking brake force by moving pads 5 to wheel disc D.

The axial stroke of output ramp 10 is not restricted by holder housing 12, because locking bosses 10c of output ramp 10 corresponding to the holes of locking ends 12a of holder housing 12 move within the holes and holder housing 12 is restricted not to move in caliper housing 4.

When the parking brake system is released, the operation is opposite to the operation when it operates. As parking cable 2 is loosened and the force pulling cable connector 15 is released by releasing parking brake operating part 1 brake force generating part 7 with cable connector 15 fixed at the end is axially moved by the elastic restoring force of spring 11 and rotated (in the opposite direction to that during the operation of the parking brake system, i.e. the direction axially far away from the wheel disc and counterclockwise). Accordingly, the pressing force applied on wheel disc D is released by the movement of brake force generating part 7 and the parking brake system is unlocked.

Accordingly, the rotational force of input ramp 8 of brake force generating part 7 is released and input ramp 8 rotates (counterclockwise) to the initial condition, and pressing plate 10b of output ramp 10 is pushed by the elastic restoring force of spring 11 and interacts with tapered rollers 9b of axial moving member 9.

Tapered rollers 9b of axial moving member 9 move along path grooves 10c of pressing plate 10b of output ramp 10. As shown in FIG. 2B, tapered rollers 9b at ends of the V-shaped cross-sectional path grooves 10c freely roll due to friction and moves inside.

As tapered rollers 9b move, input ramp 8 with released pulling force by cable connector 15 rotates counterclockwise and returns to the initial position. Accordingly, tapered rollers 9b move with respect to path grooves 10c of output ramp 10 and path groove 8c of input ramp 8 as well.

As tapered rollers 9b of axial moving member 9 move inside V-shaped cross-sectional path grooves 8c, 10c of input ramp 8 and output ramp 10, as shown in FIG. 2A, output ramp 10 and input ramp 8 return to the initial condition through rotary plate 8b and pressing plate 10b where axial moving member 9 is closely pressed.

As input ramp 8, axial moving member 9, and output ramp 10 return to the initial position, axial space L of brake force generating part 7 decreases. Accordingly, brake force transmitting part 6 and pads 5 sequentially return to the initial position, which releases pressing force applied on wheel disc D and the parking brake system is unlocked.

As described above, according to a parking brake system using tapered roller in ramp-typed caliper, since a tapered roller in ramp-typed caliper that generates parking brake force through axial force during the operation of a parking brake system is mounted, stable axial force is generated and relatively large contact areas are obtained by axial surface contacts of tapered rollers, so that it does not require forging with very high precision that is required for ball in ramp-typed ramps with point contact, thus the manufacturing process is simplified.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A parking brake system using a tapered roller in ramp-typed brake caliper for a vehicle comprising.
a parking brake operating part generating operational force to uniformly pull a parking cable through an equalizer while operating a parking lever;
a caliper unit converting the force pulling the parking cable into rotational force and axial force, and covering both sides of wheel disc to press pads against the sides and maintain brake force while operating the parking brake operating part;
a brake force transmitting part axially moving the pads to press the sides of the wheel disc, inside a caliper housing forming the whole shape to the caliper unit; and
a brake force generating part including an input ramp that has an end connected to a cable connector fastened to the parking cable at the outside of the caliper housing and rotates due to the pulling force of the cable connector, an axial moving member that has tapered rollers moving through rolling along V-shaped cross-sectional path grooves formed on the input ramp, an output ramp that has V-shaped cross-sectional path grooves for the tapered rollers to roll and is axially pushed by the movement of the tapered rollers and axially presses the brake force transmitting part, and a spring that is compressed as the output ramp axially moves and applies elastic restoring force to the output ramp when the axial force is released.

2. The parking brake system as defined in claim 1, wherein the tapered rollers of the axial moving member forming the brake force generating part are in surface contact with the path grooves of the input ramp and output ramp.

3. The parking brake system as defined in claim 2, wherein the tapered rollers and the path grooves are equally arranged at three predetermined positions of 120°.

4. The parking brake system as defined in claim 2, wherein the input ramp includes a rod that protrudes outside the caliper housing and is connected with the cable connector to rotate when the parking cable is pulled and a rotary plate having the, V-shaped cross-sectional grooves to seat the tapered rollers of the axial moving member.

5. The parking brake system as defined in claim 4, wherein the portion where the rod of the input ramp and the cable connector are connected is covered with a sealing cap to prevent oil filled ill the caliper housing from leaking and further provided with a sealing ring of an elastic material.

6. The parking brake system as defined in claim 2, wherein the axial moving member 9 includes a stationary plate that is disposed between the input ramp and the output ramp and tapered rollers that are rotatably assembled in the stationary plate and positioned in the path grooves of the input ramp and output ramp.

7. The parking brake system as defined in claim 6, wherein the axial moving member is supported by a supporting shaft by fitting through a central hole and both ends of the supporting shaft are respectively inserted in central holes of the rotary plate of the input ramp and the pressing plate of the output ramp.

8. The parking brake system as defined in claim 6, wherein the tapered roller is shaped as a longitudinally tapered cylinder of which one end is smaller than the other in diameter and the end having the larger diameter faces the outside when the tapped rollers are assembled into the stationary plate.

9. The parking brake system as defined in claim 2, wherein the output ramp includes a pressing plate having V-shaped cross-sectional path grooves to seat the tapered rollers of the axial moving member and a rod extending from the pressing plate and having a smaller diameter than that of the pressing plate to fit the spring.

10. The parking brake system as defined in claim 9, wherein the output ramp is provided with a holder housing that receives the spring and is locked by locking bosses protruding from the outer circumference of the pressing plate forming the end of the rod of the output ramp.

11. The parking break system as defined in claim 10, wherein the holder housing includes locking ends having holes with a length and width to insert and lock the protruding locking bosses of the output ramp and the portion where the locking ends start extending reduces in diameter to form a seating surface for the spring.

12. The parking brake system as defined in claim 10, wherein the locking ends of the holder housing and the locking bosses of the output ramp are equally arranged at three predetermined positions of 120°.

13. The parking brake system as defined in claim 11, wherein the length of the holes at the locking ends is determined such that the length does not restrict the stroke of the locking bosses that are moved by the output ramp while the output ramp is axially moving.
